(19) United States
(12) Patent Application Publication
(10) Pub. No.: US 2026/0327909 A1
(43) Pub. Date: Oct. 22, 2026

(54) BETAINE HYDROCHLORIDE-BASED FORMULATIONS FOR SURFACE TREATMENT OF CELLULOSIC SUBSTRATES

(71) Applicants: RAIZ - INSTITUTO DE INVESTIGAÇÃO DA FLORESTA E PAPEL, EIXO (PT); UNIVERSIDADE DE COIMBRA, Coimbra (PT)

(72) Inventors: Paulo Jorge Tavares Ferreira, Coimbra (PT); Artur José Monteiro Valente, Coimbra (PT); Mohit Sharma, Coimbra (PT); Ana Filipa Martins Lourenço, EIXO (PT)

(21) Appl. No.: 19/099,395

(22) PCT Filed: Jul. 19, 2023
(86) PCT No.: PCT/IB2023/057348

§ 371 Date: Jan. 28, 2025

(30) Foreign Application Priority Data
Jul. 28, 2022 (PT) PT118132

(51) Int. Cl. D21H 19/52; D21H 19/54; D21H 19/60; D21H 21/16

(52) U.S. Cl. CPC D21H 19/52; D21H 19/54; D21H 19/60; D21H 21/16

(57) ABSTRACT

Formulations for surface treatment of cellulosic substrates comprising betaine hydrochloride and surface treatment agents, by weight, based on the total weight of dry solids, from 5% to 20% of betaine hydrochloride and up to 95% of surface treatment agents. The formulations make it possible to obtain cellulosic substrates with comparable or increased printing properties compared to substrates that include additives commonly used in the pulp and paper industry. Additionally, the formulations allow a reduction in the consumption of optical whitening agents, and associated costs, since they do not promote the quenching phenomenon, that is, the reduction of the whitening effect potentiated by these additives. Cellulosic substrates for the application of formulations based on betaine hydrochloride.

### TECHNICAL FIELD

The present invention relates to the field of formulations for treating the surface of cellulosic substrates, particularly formulations comprising betaine hydrochloride.

### BACKGROUND ART

The surface properties of a printing and writing paper are a highly relevant aspect during its production, with characteristics such as smoothness, opacity, gloss and printability being influenced by several factors during its production, such as the orientation of the fibers, sizing treatments applied, additives used as fillers, fines content and calendering and coating processes used (Sharma et al., A review on cationic starch and nanocellulose as paper coating components, 2020, 162, pages 578-598, International Journal of Biological Macromolecules).

Coating a paper is a process in which a sheet with a uniform surface is obtained by coating cellulosic fibers and filling the space between them with binders (often starch and/or synthetic latex), pigments and/or other agents. This operation is carried out to obtain a paper with better sizing, printing and barrier properties.

Among the relevant characteristics in the evaluation of the printing quality of a written printing paper, it is also necessary to consider (in a printed paper) the whiteness of the base paper, the Gamut Area, the optical density (namely in black), the print through, and the inter-colour bleeding (ITCB).

Coating formulations usually contain different types of pigments such as ground calcium carbonate, precipitated calcium carbonate, clay, titanium dioxide, kaolin and plastic particles (Hubbe et al., Fillers for papermaking: a review of their properties, usage practices, and their mechanistic role, 2016, 11, pages 2886-2963, BioResources).

Pigments require binders in the coating formulation to fix them in the layers to be coated and to fill the small pores between them. Typically, binders such as glues, starches, styrene-butadiene latex, styrene-acrylate latex, poly(vinyl acetate) latex, polyacrylates, gums, casein protein, soy protein, and poly(vinyl alcohol) (PVA), among others, are used to facilitate the coating operation (E. Lehtinen Coating binders—general, in: E. Lehtinen, H. U. of Technology (Eds.), Pigment Coat. Surf. Sizing Pap, 1st ed. Finnish Paper Engineers' Association and TAPPI 2000, pp. 108-112).

Patent application WO2007053681A1 describes a coating formulation which, when applied to an inkjet printing substrate, improves print density, inter-colour bleeding (ITCB), print sharpness and/or drying time of image. The formulation comprises at least one pigment, preferably precipitated or ground calcium carbonate, at least one binder (an example of which is a multicomponent system including starch and polyvinyl alcohol), at least one nitrogen compound containing organic species, preferably a polymer or copolymer of diallyldimethylammonium chloride, optionally a rheology modifier, and at least one inorganic salt.

Other relevant components in these formulations are optical brightening agents (OBAS), which improve the whiteness of the paper substrate as it absorbs light in the ultraviolet region (~340-370 nm) and re-emits light in the blue region (~420-470 nm). They thus provide a fluorescent effect that reduces the yellowing of paper fibres. Most OBAs are derived from bis(triazinylamino) stilbene, differing in the number of sulfonic groups in their structures (e.g. di-, tetra- or hexasulfonated) (P. Bajpai, Optical Properties of Paper, Biermann's Handb. Pulp Pap, 2018 237-271).

Recently, studies have been found on the use of micro- and nanofibrillated celluloses (MFCs/NFCs) in formulations for coating printing and writing papers (Sharma et al., A review on cationic starch and nanocellulose as paper coating components, 2020, 162, pages 578-598, International Journal of Biological Macromolecules).

Another additive used with some frequency in paper coating formulations is calcium chloride, (CaCl₂), for improved printability. Calcium chloride improves the electrical conductivity and hence the static electricity properties of the surface layer of the paper.

The patent application WO2008048265A1 describes a substrate formed from lignocellulosic fibers which is surface treated with a formulation which includes OBAs, calcium chloride and one or more starches.

However, it is known that calcium chloride can hinder the effect of the OBAs used, and specific OBAs have been developed to overcome this problem, as is the case described in patent EP2192230B2.

The printing quality of printing and writing papers is highly relevant for the pulp and paper industries, which produce this type of product. They are looking for renewable and biodegradable alternatives to the synthetic chemicals used in the wet-end of the paper machine, in the size press or in any other step of paper production.

There is no formulation on the market of biologically based compounds, low cost and easy to apply, which allows obtaining cellulosic substrates with increased printing properties, and which allows, additionally, the substitution of salts commonly used in formulations for the surface treatment of cellulosic substrates and which lead to a decrease in the effect of other additives, such as optical brightening agents.

### SUMMARY OF INVENTION

The present invention relates to a formulation for the surface treatment of cellulosic substrates comprising, by weight, based on the total weight of dry solids, from between 5% to 20% of betaine hydrochloride and up to 95% of surface treatment agents.

According to a preferred embodiment, the formulation comprises optical brightening agents and/or surface sizing agents.

According to a preferred embodiment, the surface treatment agents are selected from the group consisting of starch, carboxymethyl cellulose, hydroxypropylmethyl cellulose, hydroxypropyl cellulose, polyvinyl alcohol and combinations thereof.

According to a preferred embodiment, the surface sizing agents are selected from the group consisting of alkyl ketene dimer, alkenyl succinic anhydride, rosin and combinations thereof.

According to a preferred embodiment, the optical brightening agents are selected from the group consisting of disulfonated, tetrasulfonated, hexasulfonated stilbene and combinations thereof.

According to a preferred embodiment, the formulation further additives selected from the group consisting of precipitated calcium carbonate, triblock copolymer, microfibrillated cellulose, nanofibrillated cellulose and combinations thereof.

According to a preferred embodiment, the cellulosic substrate is an uncoated printing and writing substrate.

According to a preferred embodiment, the cellulosic substrate is an uncoated packaging substrate.

Another aspect of the present invention relates to a cellulosic substrate comprising the formulation described in the present invention.

### BRIEF DESCRIPTION OF DRAWINGS

FIG. 1. Effect of betaine hydrochloride (BetHCl) on Gamut Area and optical density (A), and on print through and ITCB (B), in the presence of PCC (precipitated calcium carbonate), Pluronic P123 and micro/nanofibrillated celluloses (MFCs/NFCs), with compositions REF, A, B, C, D, E, F, G, H according to Table 2.

FIG. 2. Effect of OBA concentration on whiteness in the presence of starch, BetHCl and calcium chloride (CaCl₂)).

FIG. 3. Effect of OBA concentration in the Gamut Area, in the presence of BetHCl and CaCl₂).

FIG. 4. Effect of OBA concentration on optical density in the presence of BetHCl.

FIG. 5. Effect of OBA concentration on optical density in the presence of CaCl₂).

FIG. 6. Effect of OBA concentration on print through, in the presence of BetHCl and CaCl₂).

FIG. 7. Effect of OBA concentration on ITCB, in the presence of BetHCl and CaCl₂).

### DETAILED DESCRIPTION AND DESCRIPTION OF PREFERRED EMBODIMENTS

The present invention relates to a formulation for surface treatment of cellulosic substrates comprising betaine hydrochloride. This compound, commonly used as a food digestive, is, in this invention, used in a formulation for surface treatment of cellulosic substrates, through its direct application, and not for the synthesis of modified starches for use as additives in the production of, for example, paper for printing and writing (such as starch betainate (a cationic starch ester)). There is thus, inevitably, a reduction in the production costs of cellulosic substrates, with the elimination of the synthesis steps of the mentioned additives.

The formulations of this invention, comprising betaine hydrochloride, allow obtaining cellulosic substrates with comparable or increased printing properties compared to substrates that include additives commonly used to improve printing properties. It was simultaneously observed that the application of this formulation leads to a coating with low weight gain and with excellent uniformity.

Additionally, the formulations betaine with hydrochloride described in this invention allow a reduction in the consumption of OBAs and, thus, consequently, a reduction in costs associated with the production of cellulosic substrates for printing and writing and for packaging. This is due to the fact that the phenomenon of quenching was not observed, that is, the decrease in the whitening effect enhanced by other additives such as optical whitening agents.

The present invention relates to formulations for treating the surface of cellulosic substrates comprising, by weight, based on the weight of total dry solids, from 5% to 20% of betaine hydrochloride and up to 95% of a surface treatment agent.

In the context of the present invention, a surface treatment refers to any method of applying any formulation on one or both surfaces of a cellulosic substrate, with the aim of improving its properties. Possible to be used in this invention are, but not limited to, coating, spraying and size press application methods.

In the context of the present invention, surface treatment agents are used, which refers to any compound used in a surface treatment as described above. In the invention presented herein, compounds such as, for example, but not limited to, starch, carboxymethyl cellulose, hydroxypropylmethyl cellulose, hydroxypropyl cellulose, polyvinyl alcohol and combinations thereof can be used.

In the context of the present invention, cooked starch refers to starch that is cooked prior to its addition to the papermaking process, involving cooking it in distilled water and using a subsequently denatured α-amylase buffer solution.

In the context of the present invention, surface sizing agents can be used, which make it possible to improve the water resistance of a cellulosic substrate. In the invention disclosed herein, compounds such as, for example, but not limited to, alkyl ketene dimer (AKD), alkenyl succinic anhydride (ASA), copolymers of styrene and acrylate or maleic anhydride, and combinations thereof can be used.

In the context of the present invention, cellulosic substrate refers to any substrate comprising cellulosic fibers such as, but not limited to, uncoated printing and writing and packaging papers.

Also considered in this invention are formulations comprising betaine hydrochloride, micro/nanofibrillated cellulose (MFCs/NFCs), triblock copolymer (Pluronic P123) and precipitated calcium carbonate (PCC), which allow obtaining even more distinctive printing characteristics.

The present invention also considers formulations for surface treatment of cellulosic substrates obtained by simultaneous cooking of a surface treatment agent and micro/nanofibrillated celluloses (MFCs/NFCs). MFCs/NFCs are produced by passing through a high pressure homogenizer fibers subjected to mechanical, enzymatic or chemical pre-treatments (TEMPO-mediated oxidation or cationization), resulting, respectively, in micro- and nano-fibrillated celluloses called m-MFC, and -MFC, t-NFC and c-NFC.

In the context of the present invention, Kraft refers to Kraft cooking, or sulfate cooking. This chemical process consists of cooking the wood in a cooking liquor usually made up of sodium hydroxide and sodium sulfide, at temperatures of the order of 140 to 180° C.

In the context of the present invention, Kraft pulp refers to the pulp obtained by the Kraft cooking.

In the context of the present invention, unbleached Kraft pulp refers to pulp produced using the Kraft cooking process and which is not subjected to additional bleaching steps.

In the context of the present invention, bleached Kraft pulp refers to a pulp produced through the Kraft cooking process and which is also subjected to a bleaching step, whose purpose is the continuation of delignification by the action of oxidizing agents, such as oxygen, chlorine dioxide and hydrogen peroxide.

In the context of the present invention, and according to the ISO/TS 20477 standard, micro/nanofibrillated cellulose refers to cellulose fibers composed of at least one elementary fibril, with crystalline, paracrystalline and amorphous regions, with an aspect ratio (length/diameter) greater than 10, cross section from 3 to 100 nm and lengths up to 100 μm, which may contain longitudinal fibrils, intertwining between particles or net-like structures, being produced from cellulose fibers subjected to mechanical, chemical, enzymatic treatments or a combination of these.

In the context of the present invention, Gamut Area (AG) refers to the area of a hexagon whose vertices are the CIElab chromatic coordinates a* and b* of six printed colors (red, green, blue, cyan, magenta and yellow), with a* on the chromatic axis representing a color between green (−100) and red (+100), and b* on the chromatic axis which represents a color between blue (−100) and yellow (+100).

In the context of the present invention, Gamut Volume (VG) refers to the volume of a polyhedron whose vertices are the CIElab chromatic coordinates a*, b* and L of areas printed with seven colors (red, green, blue, cyan, magenta, yellow and black), and of a unprinted area (considered white), with a* on the chromatic axis representing a color between green (−100) and red (+100), b* on the chromatic axis representing a color between blue (−100) and yellow (+100) and L on the chromatic axis which represents a color between black (0) and white (+100).

In the context of the present invention, optical density (OD) refers to the result of applying the equation:

$$Optical Density = {log}_{10} \frac{1}{R} = {log}_{10} \frac{{I}_{0}}{I}$$

where R represents the reflectance, I₀ the intensity of the incident beam and I the intensity of the beam reflected by a printed patch. Black optical density refers to the optical density measured on a printed black patch.

In the context of the present invention, print through (of a printed paper) refers to the result of applying the equation:

$$print through = \sqrt{{( {L}_{p}^{*} - {L}_{u}^{*} )}^{2} + {( {a}_{p}^{*} - {a}_{u}^{*} )}^{2} + {( {b}_{p}^{*} - {b}_{u}^{*} )}^{2}}$$

where L is on the chromatic axis that represents brightness, between 0 (black) to 100 (white), a* is on the chromatic axis that represents a color between green (−100) and red (+100), and b* is on the chromatic axis that represents a color between blue (−100) and yellow (+100). The subscripts u and p respectively refer to an unprinted area and to the opposite side of a black printed area on the sheet of paper.

In the context of the present invention, inter-colour bleeding (ITCB) relates to the mixing of dissimilar adjacent colors, expressed in the irregularity (geometric distortion) of the boundary line, and is given by the standard deviation of the distribution of residues of the line adjusted to its ideal limit. The greater the irregularity, the worse the ITCB.

In the context of the present invention, a triblock copolymer, namely Pluronic P123, concerns molecules obtained by joining three polymeric segments, the central part being different from the two external segments, and the latter being equal to each other. It includes ethylene oxide (EO) and polypropylene oxide (PO) units and polymers are represented as (EO)x(PO)y(EO)x. EO groups tend to be more hydrophilic and PO groups more hydrophobic, so that in aqueous solution these molecules tend to form micelles at the critical micellar concentration. However, these properties can be modified depending on the conditions of the aqueous medium, such as temperature, pH or presence of salts. Furthermore, by varying the number of EO or PO segments, a wide variety of polymers with different hydrophobicity and molecular weight are obtained.

In the context of the present invention, an optical brightening agent (OBA) refers to a colorless or faintly colored organic chemical compound that, in solution or applied to a substrate, absorbs radiation in the ultraviolet region of the spectrum (340-380 nm), and re-emits most of the absorbed energy as bluish-violet light (400-500 nm). Among the optical brightening agents that can be used in this invention are those containing two, four or six sulfonic groups such as, for example, but not limited to disulfonated, tetrasulfonated or hexasulfonated stilbene.

In the context of the present invention, whiteness, defined by the CIE (International Commission on Illumination), is determined by the diffuse reflectance factor of a sheet of paper or cardboard using the entire visible spectrum, considering the illuminant D65 and the standard observer at 10 degrees (D65/10). The result is calculated as a percentage and a spectrophotometer is used to measure the whiteness of the paper.

Embodiments examples of the present invention are presented below, non-limiting and non-restricted, with this invention including any obvious modification, and equivalent to what is described herein.

### EXAMPLES

Among the possible surface treatment agents, surface sizing agents and optical brightening agents that can be used in the present invention, were selected as an example of an embodiment of the invention: starch, an alkyl ketene dimer (AKD) and an hexasulfonated and stilbene-based optical brightening agent. It should be noted that the amount of AKD is residual and present both in the reference formulations and in the formulations of this invention.

An uncoated printing and writing paper was selected for the cellulosic substrate.

### Materials

Corn starch, BetHCl (99%), bleached eucalyptus kraft pulp (BEKP), bleached pine kraft pulp (BPKP), α-amylase (in standard buffer solution, pH 5.8), precipitated calcium carbonate (PCC), a hexasulfonated optical brightening agent (OBA) based on stilbene and an industrially sourced alkyl ketene dimer (AKD). A triblock copolymer (Pluronics-P123) with a molecular weight (MW) 5750 g mol⁻¹ and an amount of ethylene oxide (EO) 30% by weight was considered.

### Production of MFCs/NFCs

Two types of MFC were produced, microfibrillated cellulose obtained exclusively mechanically (m-MFC) and microfibrillated cellulose obtained via enzymatic pretreatment followed by mechanical treatment (e-MFC). To produce e-MFC, BEKP (17°SR) was milled (to 4.5% consistency) and refined to 25° SR. Thereafter, it was subjected to enzymatic pretreatment, consisting of 0.17 ml of an enzymatic cocktail per kg of fiber (on a dry weight basis), for 2 h at 50° C. and pH 6.5. Then, a second refining stage (80° SR) was carried out before homogenization at 750 bar using a high pressure homogenizer (HPH, GEA Niro Soavi, model Panther NS3006L). In the case of m-MFC, BPKP was only heavily refined on a disk refiner.

Likewise, two types of NFC were used: nanocellulose obtained by TEMPO-mediated oxidation (t-NFC) and cationized nanocellulose obtained via Girard T reagent (c-NFC).

t-NFC was prepared as described in Lourenço and co-authors (AF, Gamelas JAF, Nunes T, et al (2017) Influence of TEMPO-oxidised cellulose nanofibrils on the properties of filler-containing papers. Cellulose 24:349-362) In summary, BEKP was refined to 4000 rev. in a PFI refiner, and NaBr (0.016 g/g fiber) and tetramethylpiperidine N-oxyl radical (TEMPO) (0.016 g/g fiber) were added to the pulp mixture, followed by the addition of NaClO solution (11 mmol NaClO/g fiber), keeping the pH at 10 for two hours. Afterwards, the oxidized samples were processed in the HPH, first with a passage at 500 bar and then with a passage at 1000 bar, to obtain the t-NFC (COOH content: 1332 μmol/g).

c-NFC was prepared as described in Pedrosa et al. (J. Pedrosa et al., Effect of cationization pretreatment on the properties of cationic Eucalyptus micro/nanofibrillated cellulose, International Journal of Biological Macromolecules, 2022, 468-479). Briefly, BEKP (2.5% w/w) was oxidized using sodium periodate (0.55 mol/mol AGU) in isopropanol/water (1:9, v/v) for 4 h at 70° C. Oxidized BEKP (5%, w/w), with a degree of substitution (DS) of 0.48, was catalyzed using Girard T reagent (0.7 mol/mol aldehyde) in aqueous acetic acid (10%, p/p). The modified pulp was processed twice in the HPH, first with a run at 500 bar and then with a run at 700 bar, to obtain c-NFCs with a DS of 0.16. All M/NFC samples were characterized, and the results are summarized in Table 1.

TABLE 1
Properties of micro and nanofibrillated celluloses.

| | Nanofibrillation | Zeta | Intrinsic | |
|---|---|---|---|---|
| | Yield | Potential | Viscosity | Polymerization |
| M/NFCs | (%) | (mV) | (mL/g) | degree |
| m-MFC | 17 | −27 ± 1 | 699 | 1869 |
| e-MFC | 2.5 | −12 ± 1 | 664 | 1747 |
| t-NFC | 100 | −45 ± 2 | 130 | 309 |
| c-NFC | 98 | +27 ± 2 | 20 | 244 |

### Paper Surface Treatment

Formulations, with 6-8% total solids concentration, were applied to the surface of the cellulosic substrate by roller coating, resulting in a coating of 1.5 to 3 g/m² (dry basis).

A Mathis laboratory coater (SVA-IR-B) with an infrared system attached to the applicator bar was used to coat an industrial, calendered, uncoated paper (base paper, (BP)) produced from BEKP with a grammage of base of ≈78 g·m⁻². A 13 mm (diameter) roller applicator was used at a speed of 6 m·min⁻¹ and intermediate load on both sides to obtain a dry coating layer of 1.5-3.0 g·m⁻² on one side of the BP. All coated papers were air dried at room temperature.

The difference between the weights of the air-dried coated paper sheet and the respective air-dried BP sheet was used to calculate the coating weight (ISO 536:1995). All coated papers were kept under controlled temperature (23±1° C.) and humidity (50±2%) conditions before characterization. Three sheets of paper were coated for each formulation and characterized to assess print quality.

### Printing Quality

An inkjet printer (HP Officejet Pro 6230) was used to print in color all coated papers, other than BP, as a reference. Seven different areas and colors were printed (black, red, green, blue, cyan, magenta and yellow), as well as lines (black, black on yellow background and yellow on yellow, black background) and dots (black and magenta). The printed sheets were kept for 4 h under controlled conditions of temperature (23±1° C.) and humidity (50±2%) before any characterization.

An X-Rite Eye One XTreme UV-Cut spectrophotometer was used to quantify the reflectance of six color points, in this sequence: red, green, cyan, blue, magenta, and yellow, after activation of UV light (D50, 2°). The Gamut Area (AG) was calculated from the CIE L*a*b* coordinates that resulted from the reflectance measurements at the six points. Additionally, the CIElab a* and b* coordinate values at these six points, a point printed with black and an unprinted zone (white) were determined to calculate the Gamut Volume (VG) of the printed sheets of paper.

Other print properties, such as OD (black) and print through, were evaluated using a QEA PIAS-II spectrophotometer with a low-resolution optical module (33 μm/pixel with a visual area of 21.3 mm×16 mm), whose software (PIAS II) is based on the ISO 13660 standard. Equation 1 was used to calculate the relative OD, which was then corrected by subtracting the OD of an unprinted paper point to obtain the absolute OD. Equation 2 was used to calculate the print through, using the CIElab coordinates of the colors black, white, cyan, magenta and yellow, obtained with the QEA PIAS-II.

### Evaluation of Other Paper Properties

Bendtsen Roughness (ISO 5636-3, 8791-2) and Gurley Air Permeability (ISO 5636/5) were measured for the coated papers using Frank-PTI the respective tests. An Elrepho spectrophotometer with D65 illuminant was used to measure the whiteness (CIE W D65/10) of the coated papers. For contact angle, Bendtsen roughness, Gurley air permeability and whiteness, the mean value and standard deviation of four independent measurements were calculated.

### Example 1

### Preparation of Surface Treatment Formulations with Betaine Hydrochloride and Analysis of its Properties

The MFC/NFC was added to the starch solution, cooked together with the MFC/NFC for 5 minutes at 80° C. and an α-amylase buffer, and then heated to 90-95° C. and maintained at that temperature for 15 min, to obtain a homogeneous macroscopic dispersion.

To evaluate the properties, printing different concentrations of M/NFC, starch betainate, P123, PCC, OBA and AKD were chosen, as indicated in Table 2. All percentages express the weight of the coating component, based on the total weight of dry solids. Cooked native starch was always used as the host polymer, and each formulation contained 6% OBA and 0.4% AKD. The considered reference formulation (REF) contained 93.6% native starch, 6% OBA and 0.4% AKD.

TABLE 2
Composition of coating formulations with BetHll,
comprising varying amounts of P123, PCC and M/NFCs.

| | Components concentration (% w/w) in the | | | | | | | |
|---|---|---|---|---|---|---|---|---|
| | coating formulations | | | | | | | |
| | Formulations | | | | | | | |
| Components | A | B | C | D | E | F | G | H |
| BetHCl | 16 | 16 | 16 | 16 | 16 | 16 | 16 | 16 |
| m-MFC | - | - | - | - | 16 | - | - | - |
| e-MFC | - | - | - | - | - | 16 | - | - |
| t-NFC | - | - | - | - | - | - | 16 | - |
| C-NFC | - | - | - | - | - | | - | 16 |
| P123 | - | | 5 | 5 | 5 | 5 | 5 | 5 |
| PCC | - | 16 | | 16 | 16 | 16 | 16 | 16 |

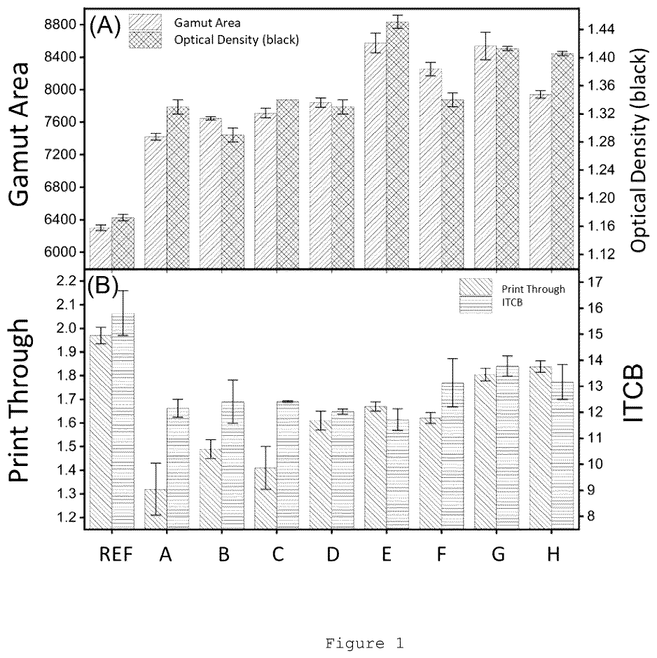

Table 3 and FIG. 1 present the results obtained for the Gamut Area, optical density, print through and ITCB for the different formulations considered.

TABLE 3
Gamut Area, optical density, print through and ITCB
values for the different formulations considered.

| Formulations | Gamut Area | DO | Print through | ITCB |
|---|---|---|---|---|
| REF | 6301 ± 35 | 1.173 ± 0.005 | 1.970 ± 0.035 | 15.816 ± 0.867 |
| A | 7421 ± 41 | 1.330 ± 0.010 | 1.320 ± 0.110 | 12.160 ± 0.350 |
| B | 7646 ± 20 | 1.290 ± 0.010 | 1.490 ± 0.040 | 12.410 ± 0.840 |
| C | 7713 ± 61 | 1.340 ± 0.001 | 1.410 ± 0.090 | 12.420 ± 0.030 |
| D | 7840 ± 58 | 1.330 ± 0.010 | 1.610 ± 0.040 | 12.030 ± 0.100 |
| E | 8576 ± 121 | 1.451 ± 0.009 | 1.670 ± 0.020 | 11.720 ± 0.420 |
| F | 8254 ± 82 | 1.340 ± 0.010 | 1.621 ± 0.023 | 13.135 ± 0.931 |
| G | 8539 ± 168 | 1.413 ± 0.003 | 1.805 ± 0.027 | 13.780 ± 0.394 |
| H | 7943 ± 47 | 1.406 ± 0.003 | 1.839 ± 0.025 | 13.169 ± 0.676 |

As shown in FIG. 1A and Table 3, the formulation with BetHCl (formulation A) resulted in an increase in the Gamut Area from 6301 to 7421, which corresponds to an increment of 18%, compared to the reference formulation. With formulation B, additionally containing PCC, an increase in the Gamut Area from 6301 to 7646 was observed, which corresponds to an increase of 21%, compared to the reference formulation. With formulation C, additionally containing P123, an increase in the Gamut Area from 6301 to 7713 was observed, which corresponds to an increase of 22%, in comparison with the reference formulation. With formulation D, which considers the incorporation of BetHCl, PCC and P123, an increase in the Gamut Area from 6301 to 7840 was observed, which corresponds to an increase of 248, in comparison with the reference formulation. The complementary addition of m-MFC, together with the above-mentioned components (formulation E), resulted in an increase in the Gamut Area from 6301 to 8576, which corresponds to an increase of 36%, in comparison with the reference formulation (the highest increase among all formulations). For formulations F, G and H, that is, with the incorporation of e-MFC, t-NFC and c-NFC, increases were observed in the Gamut Area values from 6301 (reference formulation) to 8254, 8539 and 7943, corresponding to increments of 31%, 36% and 26%, respectively. An increase in the Gamut Area values was thus observed, only with the inclusion of BetHCl, and comparable or even greater increases, in preferred forms of this invention, which include additional components such as PCC, P123 and micro and nanofibrillated celluloses.

FIG. 1A also represents the optical density (OD) (black) of papers coated with BetHCl. With formulation A, an increase in optical density from 1.173 to 1.330 was observed, corresponding to an increase of 13% compared to the reference formulation. With formulation B, an increase in optical density from 1.173 to 1.290 was observed, corresponding to an increase of 10% compared to the reference formulation. With formulation C, an increase in optical density from 1.173 to 1.340 was observed, corresponding to an increase of 14% compared to the reference formulation. With formulation D, an increase in optical density from 1.173 to 1.330 was observed, corresponding to an increase of 13% compared to the reference formulation. For formulation E, an increase in optical density to 1.451 was observed, corresponding to an increase of 24% compared to the reference formulation. For formulations F, G and H, that is, with the incorporation of e-MFC, t-NFC and c-NFC, increases in optical density values from 1.173 (reference formulation) to 1.340, 1.413 and 1.406 were observed, corresponding to increments of 148, 20% and 20%, respectively. An increase in the optical density values was thus observed, only with the inclusion of BetHCl, and comparable or even greater increases, in preferred forms of this invention, which include additional components such as PCC, P123 and microfibrillated celluloses.

As represented in FIG. 1B and Table 3, a decrease in the values of print through (desired) was observed with formulation A, in relation to the values obtained with the reference formulation, which is in accordance with the increase in the contact angle with water (Table 3). With the remaining formulations, a smaller decrease in the print through values was observed, in relation to the values obtained with the reference formulation. The same happened with formulation C, changing the ITCB from 15.816 (reference formulation) to 12.420, which corresponds to a decrease of 21%, and with formulation D, changing the ITCB from 15.816 (reference formulation) to 12.030, which corresponds to a decrease of 24%. Similarly, for formulations E, F, G and H, that is, with the incorporation of m-MFC, e-MFC, t-NFC and c-NFC, improvements of 26%, 17.0%, 13% and 17%, corresponding to ITCB values of 11.720, 13.135, 13.780 and 13.169, respectively. An improvement of the ITCB was thus observed, only with the inclusion of BetHCl. Similar, or even greater improvements, have been observed for preferred forms of this invention, which include additional components such as PCC, P123, and micro- and nanofibrillated celluloses.

Table 4 shows that the whiteness was not reduced with the use of BetHCl, as demonstrated with formulation A, in which the whiteness value varied only from 163 (value for the reference formulation) to 165, corresponding to an increment of 1%. Additionally, except for formulation H, a slight increase in whiteness was observed compared to that of the reference formulation, up to 169 with formulation D, corresponding to an increase of 4% compared to the reference formulation. Thus, the phenomenon of degradation of the effect of the OBA additive is not observed with the use of BetHCl, as is commonly observed with other salts commonly used in the pulp and paper industry.

Significant variations were observed in the Bendtsen roughness and Gurley air permeability values.

Similar to the Gamut Area values, as shown in Table 4, for the Gamut Volume the formulation with BetHCl (formulation A) resulted in an increase from 165×10³ to 132×10³, which corresponds to an increment of 25%, comparing with the reference formulation. With formulation B, an increase in the Gamut Volume from 132×10³ to 168×10³ was observed, which corresponds to an increase of 27% compared to the reference formulation. With formulation C, an increase in the Gamut Volume from 132×10³ to 173×10³ was also observed, an increase of 31%, also in comparison with the reference formulation. Formulation D, including BetHCl, PCC and P123, showed an increase in Gamut Volume from 132×10³ to 177×10³, i.e., a 34% increment, again compared to the reference formulation. The addition of m-MFC (formulation E) resulted in an increase in the Gamut Volume from 132×10³ to 202×10³, which corresponds to an increase of 53% compared to the reference formulation. Formulations F, G and H, which correspond to incorporations of e-MFC, t-NFC and c-NFC, respectively, showed increases in Gamut Volume values from 132 (reference formulation) to 188×10³, 198×10³ and 183×10³, corresponding to increments of 42%, 50% and 39%, respectively. Thus, as also observed for the Gamut Area, there was an increase in the Gamut Volume values, only with the inclusion of BetHCl, and comparable or even greater increments, in preferred forms of this invention, which include additional components such as PCC, P123 and micro celluloses and nanofibrillated.

TABLE 4
Properties of papers coated using BetHCl in the
presence of PCC, P123 and M/NFCs in starch-based coating formulations.

| | Weight gain | Roughness | Gurley | Contact angle | | Gamut Volume |
|---|---|---|---|---|---|---|
| Formulations | (g/m²) | (mL/min) | (mL/min) | (°) | Whiteness | (10³) |
| Reference | 1.8 ± 0.3 | 329 ± 13 | 318 ± 7 | 72 ± 1 | 163 ± 1 | 132 ± 1 |
| (native | | | | | | |
| starch) | | | | | | |
| A | 2.6 ± 0.1 | 352 ± 15 | 269 ± 27 | 88 ± 1 | 165 ± 1 | 165 ± 1 |
| B | 2.5 ± 0.3 | 313 ± 18 | 278 ± 27 | 78 ± 1 | 164 ± 1 | 168 ± 1 |
| C | 2.7 ± 0.3 | 345 ± 49 | 190 ± 2 | 43 ± 1 | 168 ± 1 | 173 ± 1 |
| D | 2.8 ± 0.2 | 343 ± 26 | 213 ± 45 | 41 ± 2 | 169 ± 1 | 177 ± 2 |
| E | 2.5 ± 0.5 | 407 ± 16 | 281 ± 11 | 42 ± 2 | 168 ± 1 | 202 ± 3 |
| F | 2.8 ± 0.1 | 346 ± 09 | 349 ± 8 | 32 ± 1 | 167 ± 1 | 188 ± 2 |
| G | 2.5 ± 0.4 | 463 ± 60 | 303 ± 22 | 45 ± 1 | 164 ± 2 | 198 ± 4 |
| H | 2.7 ± 0.1 | 374 ± 15 | 321 ± 3 | 48 ± 1 | 128 ± 2 | 183 ± 1 |

### Example 2

Whiteness Analysis Comparing the Use of BetHCl with the Use of CaCl₂

Whiteness, positively correlated with ISO brightness, represents the ability of a paper to equally reflect a balance of all wavelengths of light across the entire visible spectrum (Hu et al., Relationship between paper whiteness and color reproduction in inkjet printing, 2017, 12, pages 4854-4866, BioResources). The addition of OBA on the paper surface is an economical solution to increase the whiteness of printing and writing papers (Shi et al., Review: Use of optical brightening agents (OBAs) in the production of paper containing high-yield pulps, 2012, 7, pages 2582-2591, BioResources). Therefore, the interaction between OBA and the other coating components is of high relevance. To study the effect of OBA concentration on whiteness and printing properties, the coating formulation composed of BetHCl was prepared according to the concentrations shown in Table 5. Similar concentrations were also used with a common coating agent (CaCl₂)) to compare whiteness and printing quality results, as shown in Table 4. A native starch reference formulation was also considered. Each formulation contained 0.4% AKD.

TABLE 5
Composition of coating formulations with BetHCl and
CaCl2, covering variable amounts of OBA.

| | Concentration of components (% w/w) in coating | | | | | | | |
|---|---|---|---|---|---|---|---|---|
| | formulations | | | | | | | |
| | BetHCl formulations | | | | CaCl₂ formulations | | | |
| Components | I | J | K | L | M | N | O | P |
| BetHCl | 16 | 16 | 16 | 16 | | | | |
| CaCl₂ | | | | | 16 | 16 | 16 | 16 |
| OBA | 0 | 2 | 4 | 6 | 0 | 2 | 4 | 6 |
| Native | 83.6 | 81.6 | 79.6 | 77.6 | 83.6 | 81.6 | 79.6 | 77.6 |
| starch | | | | | | | | |

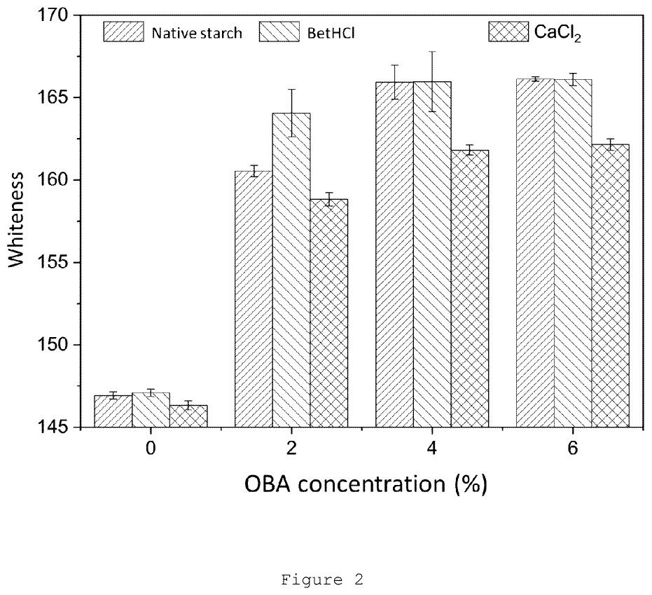

Table 6 and FIG. 2 represent the whiteness values obtained for the different formulations considered in Table 3.

TABLE 6
Whiteness values for the considered formulations.

| OBA | Whiteness | | | | |
|---|---|---|---|---|---|
| concentration | Native | | | | |
| (% w/w) | starch | BetHCl formulations | | CaCl₂ | |
| 0 | 146.93 ± | I | 147.09 ± | M | 146.33 ± |
| | 0.22 | | 0.23 | | 0.27 |
| 2 | 160.54 ± | J | 164.06 ± | N | 158.82 ± |
| | 0.34 | | 1.44 | | 0.41 |
| 4 | 165.94 ± | K | 165.97 ± | O | 161.81 ± |
| | 1.03 | | 1.82 | | 0.31 |
| 6 | 166.12 ± | L | 166.10 ± | P | 162.14 ± |
| | 0.13 | | 0.37 | | 0.36 |

In FIG. 2, the whiteness of papers coated with starch, BetHCl and CaCl₂ was compared for varying concentrations of OBA. Whiteness improved by 9% when the OBA concentration was increased from 0 to 2% using the native starch formulation, changing from 146.93 to 160.54. Substituting native starch for the improvement BetHCl, 12% OBA was when the concentration was increased from 0 to 2%, changing from 147.09 (I) to 164.06 (J). In the presence of CaCl₂), whiteness also improved by only 9% when the OBA concentration was increased from 0 to 28, changing from 146.33 (M) to 158.82 (N).

With further increase in OBA concentration from 2% to 4%, whiteness increased for all coated sheets: up to 165.94 in the presence of native starch (13% increase over the reference formulation of native starch without OBA), up to 165.97 (K) in the presence of BetHCl (13% increase compared to the reference formulation of BetHCl without OBA) and up to 161.81 (O) in the presence of CaCl₂) (increase of 11% compared to the reference formulation of CaCl₂) without OBA).

For any concentration of OBA used, the whiteness of papers surface-treated with CaCl₂) formulations was lower than for papers surface-treated with both starch and BetHCl formulations.

In the presence of CaCl₂), the whiteness reduction can be explained by the presence of cationic charges, which degrade the OBA and cause the whiteness reduction. On the contrary, this reduction was not observed for papers superficially treated with BetHCl, which presented whiteness similar to papers coated with starch. Thus, there was no OBA degradation in presence the of BetHCl in coating formulations.

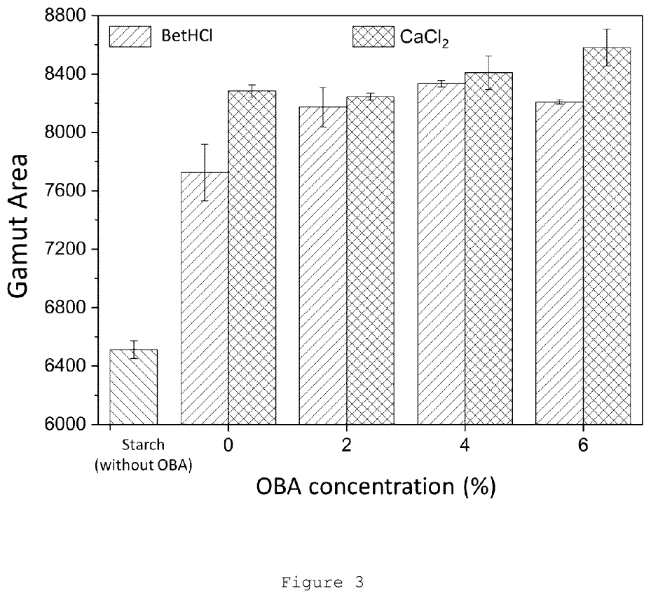

Additionally, results of Gamut Area, optical density (black), print through (of a printed paper) and inter-color bleeding (ITCB) were also evaluated and compared, for papers with formulations of BetHCl and CaCl₂). Slight differences in the results shown above were related to the use of different/new cartridges in the considered printer. Furthermore, the Gamut Area of papers coated with BetHCl and CaCl₂) was compared with that of a native starch formulation (without OBA) and for an increase in OBA concentration, as shown in FIG. 3 and table 7.

TABLE 7
Gamut Area values for the considered formulations.

| | Gamut Area | | | |
|---|---|---|---|---|
| Starch | 6512 ± 60 | | | |
| (no OBA) | | | | |
| OBA | | | | |
| concentration | | | | |
| (% w/w) | BetHCl formulations | | CaCl₂ formulations | |
| 0 | I | 7726 ± 194 | M | 8283 ± 40 |
| 2 | J | 8173 ± 135 | N | 8245 ± 24 |
| 4 | K | 8334 ± 22 | O | 8408 ± 114 |
| 6 | L | 8208 ± 15 | P | 8581 ± 126 |

In the absence of an optical brightening agent (OBA), the Gamut Area values obtained with the formulations with BetHCl (I, 7726) and with CaCl₂) (M, 8283) are higher than those obtained with the starch formulation (6512), corresponding to increments of 19% and 27%, respectively.

For the BetHCl formulations, taking as a reference the formulation without OBA (formulation I), the J, K and L formulations, which correspond to incorporations of 2%, 4% and 6% by weight of OBA, respectively, there was an increase in the value of the Gamut Area from 7726 to a maximum of 8334, corresponding to an increment of up to 8%.

For the CaCl₂) formulations, taking as a reference the formulation without OBA (formulation M), the N, O and P formulations, which correspond to incorporations of 28, 4% and 6% by weight of OBA, respectively, there was an increase in the value of the Gamut Area from 8283 to a maximum of 8581, corresponding to an increment of up to 4%.

Considering 4% of OBA concentration, the paper coated with the BetHCl formulation showed an increase of 8% in the Gamut Area values and, also, increments in the whiteness values in the order of 13%. However, 4 wt % OBA increased the Gamut Area with the presence of CaCl₂) but, at the same time, showed a comparatively lower whiteness compared to the value obtained with the BetHCL formulation, of 161.8 and 166.0 respectively.

With the BetHCl formulation, simultaneous and significant increments of Gamut Area and whiteness were possible. Also here, a degradation of the effect of the OBA additive was not observed.

Additionally, other printing properties were also compared.

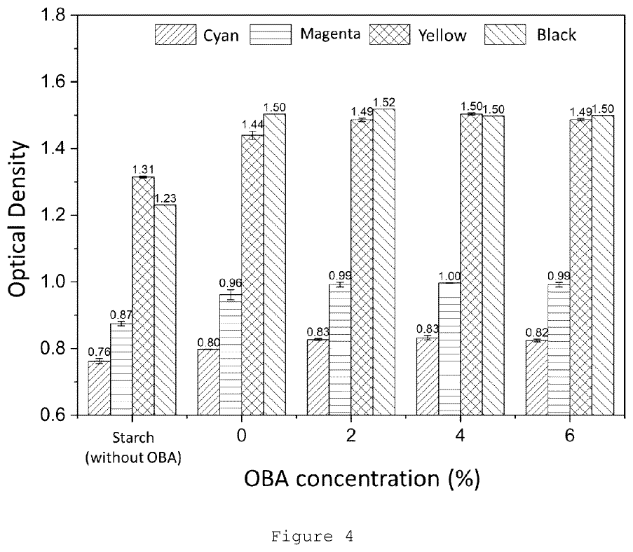

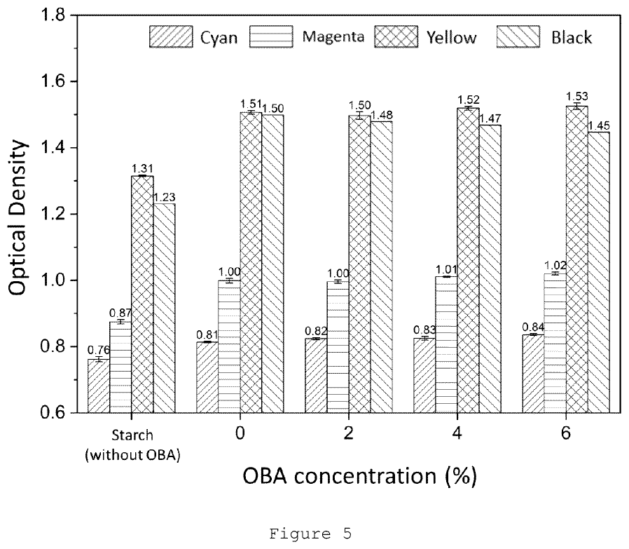

The optical density for cyan, magenta, yellow and black is shown in FIG. 4 and FIG. 5 for papers coated with BetHCl and CaCl₂, respectively. Tables 8 and 9 present the corresponding values.

TABLE 8
Optical density values for the considered BetHCl formulations.

| | Optical density | | | | |
|---|---|---|---|---|---|
| | Cyan | | Magenta | Yellow | Black |
| Starch | 0.762 ± 0.007 | | 0.875 ± 0.007 | 1.315 ± 0.002 | 1.231 ± 0.019 |
| (without | | | | | |
| OBA) | | | | | |
| OBA | | | | | |
| concen- | | | | | |
| trations | | | | | |
| (% w/w) | BetHCl formulations | | | | |
| 0 | I | 0.798 ± 0.001 | 0.962 ± 0.015 | 1.439 ± 0.013 | 1.504 ± 0.017 |
| 2 | J | 0.827 ± 0.003 | 0.992 ± 0.007 | 1.486 ± 0.005 | 1.519 ± 0.015 |
| 4 | K | 0.833 ± 0.007 | 0.996 ± 0.001 | 1.504 ± 0.004 | 1.498 ± 0.009 |
| 6 | L | 0.824 ± 0.004 | 0.992 ± 0.007 | 1.487 ± 0.004 | 1.499 ± 0.002 |

TABLE 9
Optical density values for the considered CaCl₂ formulations.

| | Optical density | | | | |
|---|---|---|---|---|---|
| | Cyan | | Magenta | Yellow | Black |
| Starch | 0.762 ± 0.007 | | 0.875 ± 0.007 | 1.315 ± 0.002 | 1.231 ± 0.019 |
| (without | | | | | |
| OBA) | | | | | |
| OBA | | | | | |
| concen- | | | | | |
| trations | | | | | |
| (% w/W) | CaCl₂ formulations | | | | |
| 0 | M | 0.814 ± 0.002 | 0.999 ± 0.007 | 1.507 ± 0.006 | 1.499 ± 0.023 |
| 2 | N | 0.824 ± 0.004 | 0.996 ± 0.005 | 1.497 ± 0.011 | 1.478 ± 0.003 |
| 4 | O | 0.825 ± 0.006 | 1.011 ± 0.002 | 1.519 ± 0.006 | 1.468 ± 0.007 |
| 6 | P | 0.836 ± 0.003 | 1.020 ± 0.005 | 1.525 ± 0.009 | 1.447 ± 0.022 |

Comparing the BetHCl and CaCl₂ formulations, without OBA, with the starch formulation, also without OBA, an increase in optical density was always observed. By increasing the amount of OBA, the optical density for cyan and magenta slightly increased for both types of treated papers. In the case of optical density for yellow, the increase is significant in papers coated with BetHCl, going from 1.44 (formulation I) to around 1.50 (formulations J, K and L), but in papers coated with CaCl₂ the whitener optical doesn't have much influence. In the case of optical density for black, the effect of increasing OBA concentration is not significant in the presence of BetHCl (formulations I to L), but is negative in the presence of CaCl₂ (formulations M to P).

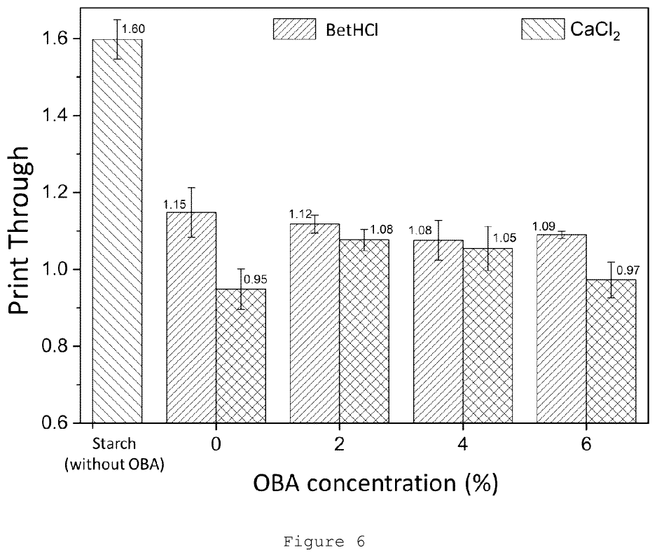

The effect of OBA concentration on the print through is shown in FIG. 6 and Table 10 for papers coated with BetHCl and CaCl₂.

TABLE 10
Print through values for the BetHCl and CaCl₂
formulations considered.

| | Print through | | | |
|---|---|---|---|---|
| Starch | 1.598 ± 0.507 | | | |
| (without OBA ) | | | | |
| OBA | | | | |
| concentrations | | | | |
| (% w/w) | BetHCl formulations | | CaCl₂ BetHCl formulations | |
| 0 | I | 1.148 ± 0.064 | M | 0.949 ± 0.053 |
| 2 | J | 1.117 ± 0.023 | N | 1.076 ± 0.028 |
| 4 | K | 1.075 ± 0.052 | O | 1.054 ± 0.058 |
| 6 | L | 1.090 ± 0.009 | P | 0.972 ± 0.047 |

Both with BetHCl and with CaCl₂, for any concentration of OBA, a smaller print through value is obtained, which is positive. On the other hand, with the increase in OBA concentration, there is generally a decrease in the print through values for both types of formulations.

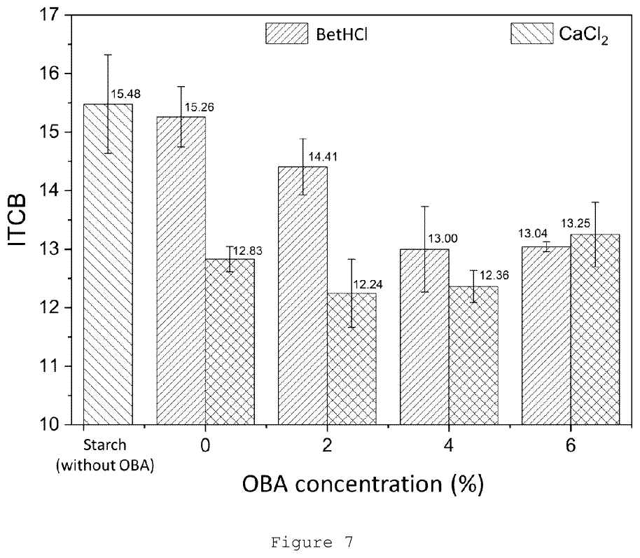

FIG. 7 and Table 11 show the results of the ITCB measurement for papers coated with BetHCl and CaCl₂, with different concentrations of OBA.

For papers treated superficially with BetHCl, the increase in OBA concentration has a positive effect on the reduction of ITCB, passing this parameter from 15,260 (formulation I) to a minimum of 13,000 about with concentrations above 4% of OBA (formulations K and L), which corresponds to a decrease of 15%. In coatings with CaCl₂ the effect of increasing the OBA concentration is not significant (M to P formulations).

TABLE 11
ITCB values for the BetHCl and CaCl₂ formulations considered.

| | ITCB | | | |
|---|---|---|---|---|
| Starch | 15.477 ± 0.843 | | | |
| (without OBA) | | | | |
| OBA | | | | |
| concentrations | | | | |
| (% w/w) | BetHCl formulations | | CaCl₂ BetHCl formulations | |
| 0 | I | 15.260 ± 0.514 | M | 12.829 ± 0.217 |
| 2 | J | 14.406 ± 0.482 | N | 12.244 ± 0.583 |
| 4 | K | 12.997 ± 0.732 | O | 12.361 ± 0.273 |
| 6 | L | 13.039 ± 0.084 | P | 13.248 ± 0.551 |

It was thus demonstrated that papers coated with BetHCl had a higher whiteness compared to papers coated with CaCl₂, thus not observing the degradation phenomenon of the OBA effect. BetHCl thus allows smaller amounts of additives to be used, presenting itself as a more economical solution for the paper production process. Additionally, formulations with BetHCl improved the print quality of cellulosic substrates, with improvements in Gamut Area, overlapping, ITCB and optical density values, most significantly for the optical density for yellow (slight increases for the optical density for cyan and for magenta, and non-significant differences for optical density for black).

### Example 3

Further Preparation of Betaine Hydrochloride Surface Treatment Formulations and Analysis of their Properties

Formulations have also been prepared for surface treatment of cellulosic substrates that include by weight, based on the total weight of dry solids, 5% of betaine hydrochloride and up to 95% of starch; or 20% of betaine hydrochloride and up to 80% of starch, also by weight, based on the total weight of dry with solids, different combinations of optical brightening agents and/or surface sizing agents as described in the previous examples.

It was also possible to verify the printing quality of cellulosic substrates, with improvements in the values of Gamut Area, print through, ITCB and optical density (namely for yellow), in line with the results of Examples 1 and 2. permanence of whiteness levels provided by OBA in cellulosic substrates superficially treated with the considered formulations. It was also verified the permanence of the levels of whiteness provided by the OBA in the cellulosic substrates superficially treated with the considered formulations.

1. A formulation for the surface treatment of cellulosic substrates comprising, by weight, based on the total weight of dry solids, from between 5% to 20% of betaine hydrochloride and up to 95% of surface treatment agents.

2. The formulation according to claim 1, wherein it comprises optical brightening agents and/or surface sizing agents.

3. The formulation according to claim 1, wherein the surface treatment agents are selected from the group consisting of starch, carboxymethyl cellulose, hydroxypropylmethyl cellulose, hydroxypropyl cellulose, polyvinyl alcohol and combinations thereof.

4. The formulation according to claim 1, wherein the surface sizing agents are selected from the group consisting of alkyl ketene dimer, alkenyl succinic anhydride, rosin and combinations thereof.

5. The formulation according to claim 1, wherein the optical brightening agents are selected from the group consisting of disulfonated, tetrasulfonated, hexasulfonated stilbene and combinations thereof.

6. The formulation according to claim 1, wherein it further comprises additives selected from the group consisting of precipitated calcium carbonate, triblock copolymer, microfibrillated cellulose, nanofibrillated cellulose and combinations thereof.

7. The formulation according to claim 1, wherein the cellulosic substrate is an uncoated printing and writing substrate.

8. The formulation according to claim 1, wherein the cellulosic substrate is an uncoated packaging substrate.

9. A cellulosic substrate comprising the formulation claimed in claim 1.
